(19) United States
(12) Patent Application Publication
(10) Pub. No.: US 2013/0307029 A1
(43) Pub. Date: Nov. 21, 2013

(54) High-Resolution Biosensor

(71) Applicants: Mingsheng Xu, Hangzhou (CN); Hongzheng Chen, Hangzhou (CN); Gang Wu, Hangzhou (CN); Minmin Shi, Hangzhou (CN); Mang Wang, Hangzhou (CN)

(72) Inventors: Mingsheng Xu, Hangzhou (CN); Hongzheng Chen, Hangzhou (CN); Gang Wu, Hangzhou (CN); Minmin Shi, Hangzhou (CN); Mang Wang, Hangzhou (CN)

(21) Appl. No.: 13/989,771

(22) PCT Filed: Dec. 31, 2011
(86) PCT No.: PCT/CN11/85098

§ 371 Date: May 24, 2013

(30) Foreign Application Priority Data
Apr. 19, 2011 (CN) 20110097791.0

(51) Int. Cl. G01N 27/414

(52) U.S. Cl. CPC G01N 27/4145
USPC 257/253

(57) ABSTRACT

A high-resolution biosensor for analysis of biomolecules is provided. The high-resolution biosensor comprises a functional unit comprising a conducting material with an atomic-scale thickness and a micro-nano fluidic system unit. The functional unit is capable of achieving a resolution required to detect a characteristic of individual biomolecule, and the micro-nano fluidic system unit is capable of controlling the movement and conformation of the biomolecule investigated. The functional unit comprises a first insulating layer, conducting functional layer, a second insulating layer, and a nanopore extending through the full thickness of the functional unit. The micro-nano fluidic system unit comprises a first electrophoresis electrode or micropump, a first fluidic reservoir, a second fluidic reservoir, a second electrophoresis electrode or micropump, and micro-nanometer separation channels. The nanopore connects to the micro-nanometer separation channels. Interactions between the biomolecule and conducting functional layer occur as the biomolecule translocates through the nanopore of the functional unit.

### CROSS-REFERENCE TO RELATED APPLICATION

This application is the national phase application of International application number PCT/CN2011/085098, filed Dec. 31, 2011, which claims the priority benefit of China Patent Application No. 201110097791.0, filed Apr. 19, 2011. The above-identified applications are hereby incorporated by reference in their entirety.

### TECHNICAL FIELD

The present invention relates to a sensor and, in particular, to a high resolution biosensor.

### BACKGROUND

DNA sequencing technologies are basic platforms for biomedicine research. Sanger-based DNA sequencing technique, the first generation sequencing technique, involves multiplication (amplification) of DNA molecules and fluorescent marker which may cause errors during the sequencing. Thus this sequencing process needs to be performed several times in order to get reliable results of a gene sequence. Moreover, this technique is far too slow and costly for reading personal genetic codes despite substantial improvements in the technology. It costs approximately $10-25 million to sequence a single human genome. To reduce costs and increase the speed of sequencing, the National Human Genome Research Institute of the United States initiated a program to advance the development of innovative sequencing technologies in 2004. In addition, in October 2006, the X Prize Foundation established an initiative to promote the development of full genome sequencing technologies, called the Archon X Prize, intending to award $10 million to the first team that can build a device to sequence 100 human genomes within 10 days. Second generation DNA sequencing technologies developed in recent years have yielded an increase in DNA sequencing speed. However, the cost of the sequencing remains high ($0.1-1 million) and after data acquisition, the cost for data analysis is also quite high. Furthermore, the accuracy of the second generation sequencing technologies is not comparable to that of the Sanger-based technique. Third generation sequencing technologies (e.g., nanopore sequencing) currently under development have several advantages including low cost, high sequencing speed, and high accuracy (Mingsheng Xu, et al. Small, 2009(5):2638). The underlying working principle of nanopore sequencing is that a single-stranded DNA (ssDNA) molecule is electrophoretically driven through a nanoscale pore in such a way that bases of the DNA molecule pass through the pore in strict linear sequence. A change in electrical signals such as ionic current blockages, transverse tunneling currents or capacitance, or optical signals is recorded to discriminate the order of the bases in the DNA molecule. The nanopore sequencing does not require polymerase chain reaction and fluorescent markers and thus is capable of direct readout of the sequence of the bases in the DNA molecule (M. Zwolak, M. Di Ventra, Rev. Mod. Phys. 2008(80):141-165; D. Branton et al., Nature Biotechnol. 2008(26):1146-1153). However, the depth of the nanopore made of common materials such as SiO2, SiN_{X}, or Al₂O₃, is normally greater than 10 nm, thus is significantly larger than the spacing between two adjacent bases in a ssDNA (about 0.3 nm-0.7 nm). In other words, about 15 bases can pass through the nanopore at the same time, and it thus cannot meet the single-base resolution requirement for genome sequencing. Consequently, in order to achieve the single-base resolution, a functional element with size or thickness comparable to the spacing between two adjacent DNA nucleotides that enables the detection of nucleotides in a ssDNA one at a time is needed. Furthermore, the difficulty in control of DNA velocity and orientation during the translocation through the nanopore makes the accurate sequencing of the DNA even harder.

Because each kind of the DNA bases has its unique atomic structure and chemical property, the four kinds of DNA bases have base-specific electronic characteristics. In 2005, Zwolak et al. reported that through simulation, it is possible to sequence a DNA molecule by measuring transverse tunneling current as the DNA bases translocate through a nanopore ((Zwolak et al., Electronic signature of DNA nucleotides via transverse transport, Nano Letters, 2005(5):421-424)). In 2007, Xu et al., for the first time, observed that four DNA bases have base-specific electronic fingerprints on Au(11) surface by using ultrahigh vacuum scanning tunneling microscopy, which indicates that the four kinds of DNA bases interacted with the electrode functional material differently. Therefore, based on the different interactions between the four kinds of DNA bases and the functional material, it is possible to sequence a DNA molecule by detecting changes in electrical or optical characteristics induced by interactions between the bases and the functional material built in a nanopore as bases of the DNA translocate through the nanopore. Nanopore sequencing thus is one of the most promising technologies for a rapid, low-cost DNA sequencing. As for single-base resolution DNA electronic sequencing, it requires integrating an atomic-scale electrode with a nanopore, thus the electrode can be used to record the electrical characteristics as the bases translocate through the nanopore. Although it is easy to fabricate a nanopore, the integration of an electrode capable of single-base resolution with the nanopore has not yet been reported. On the other hand, the transverse tunneling current is significantly affected by the distance between the nano-electrode and a DNA base as well as the orientation of the DNA. These factors must be well controlled in order to accomplish accurate DNA electronic sequencing.

### SUMMARY

It is thus the object of the present invention to overcome insufficiencies of current DNA electronic sequencing technologies, such as insensitivity and resolution limitations, by providing a high-resolution biosensor that can be used to electrically identify individual base in a DNA strand one at a time.

In one embodiment, the high-resolution biosensor may comprise a first fluidic reservoir 12 and a second fluidic reservoir 13 located at opposite ends of a third insulating layer 3; a first electrophoresis electrode or micropump 10 connected to the first fluidic reservoir 12; a second electrophoresis electrode or micropump 11 connected to the second fluidic reservoir 13; micro-nanometer separation channels 14 located between the first fluidic reservoir 12 and the second fluidic reservoir 13; and n field effect transistor units 30 disposed in parallel between the first fluidic reservoir 12 and the second fluidic reservoir 13 and separated from each other by the third insulating layer 3. The field effect transistor unit 30 may comprise a substrate 1; a dielectric layer 2; a source electrode 7; a drain electrode 8; a gate electrode 9; and a functional unit 20. The functional unit 20 may comprise: a first insulating layer 4; a functional layer 5; a second insulating layer 6; and a nanopore formed at a central region of the functional unit 20. The nanopore 16 may be extended through a full thickness of the functional unit 20 and connected to the first fluidic reservoir 12 and the second fluidic reservoir 13 via the micro-nanometer separation channels 14. The source electrode 7 and the drain electrode 8 are electrically connected to the functional unit 20. The first electrophoresis electrode or micropump 10, the second electrophoresis electrode or micropump 11, the first fluidic reservoir 12, the second fluidic reservoir 13, the micro-nanometer separation channels 14, and the n field-effect transistor units 30 constitute the biosensor 40. A biosensor array 50 is formed by disposing a plurality of biosensors in parallel on a chip. Here, n is an integer equal to or greater than 1.

In another embodiment, the high-resolution biosensor may comprise a field effect transistor unit and a micro-nano fluidic system unit. The field effect transistor unit may comprise a substrate, a dielectric layer, a source electrode, a drain electrode, a gate electrode, and a functional unit. The functional unit may comprise a first insulating layer, a functional layer, a second insulating layer, and a nanopore extending through a full thickness of the functional unit. The first insulating layer, the functional layer, and the second insulating layer are placed in order. The source electrode and the drain electrode are electrically connected to the functional layer. The micro-nano fluidic system unit may comprise a first fluidic reservoir, a second fluidic reservoir, a third insulating layer, and micro-nanometer separation channels. The first fluidic reservoir and the second fluidic reservoir are located at opposite ends of the micro-nano fluidic system unit. The first fluidic reservoir is connected a first electrophoresis electrode or micropump and the second fluidic reservoir is connected to a second electrophoresis electrode or micropump. The first fluidic reservoir and the second fluidic reservoir are separated by the third insulating layer. The micro-nanometer separation channels are located between the first fluidic reservoir and the second fluidic reservoir. The nanopore, the first fluidic reservoir, the micro-nanometer separation channels, and the second fluidic reservoir are aligned and connected. The third insulating layer may act as a substrate. There are n field effect transistor units that may be disposed in parallel between the first fluidic reservoir and the second fluidic reservoir and separated from each other by the third insulating layer. Here, n is an integer equal to or greater than 1. The field effect transistor unit may be referred to as a signal detection unit. The biosensor may consist of N micro-nano fluidic system units, and N is an integer equal to or larger than 1. The n field-effect transistor units and the N micro-nano fluidic system units form a biosensor array. Here, n and N are integers equal to or larger than 1.

In yet another embodiment, the high-resolution biosensor may comprise a functional unit and a micro-nano fluidic system unit. The functional unit may comprise a first insulating layer, a functional layer, a second insulating layer, and a nanopore extending through a full thickness of the functional unit. The first insulating layer, the functional layer, and the second insulating layer are placed in order. Two electrical contact layers are electrically connected the functional layer. The micro-nano fluidic system unit may comprise a first fluidic reservoir, a second fluidic reservoir, a third insulating layer, and micro-nanometer separation channels. The first fluidic reservoir and the second fluidic reservoir are located at opposite ends of the said micro-nano fluidic system unit. The first fluidic reservoir is connected to a first electrophoresis electrode or micropump and the second fluidic reservoir is connected to a second electrophoresis electrode or micropump. The first fluidic reservoir and the second fluidic reservoir are separated by the third insulating layer. The micro-nanometer separation channels are located between the first fluidic reservoir and the second fluidic reservoir. The nanopore, the first fluidic reservoir, the micro-nanometer separation channels, and the second fluidic reservoir are aligned and connected. The third insulating layer may act as a substrate. There are n functional units that are disposed in parallel between the first fluidic reservoir and the second fluidic reservoir and separated from each other by the third insulating layer. Here, n is an integer equal to or larger than 1. The functional unit may be referred to as a signal detection unit. The biosensor may consist of N micro-nano fluidic system units. N is an integer equal to or larger than 1. The n functional units and the N micro-nano fluidic system units form a biosensor array. Here, n and N are integers equal to or larger than 1.

The nanopore, the first fluidic reservoir, the micro-nanometer separation channels, and the second fluidic reservoir are aligned and connected. That is, the first fluidic reservoir is connected to a first micro-nanometer separation channel which is in turn connected to the first insulating layer of the nanopore to provide a biomolecule in a solution to the nanopore. The second insulating layer of the nanopore is connected to a second micro-nanometer separation channel which is in turn connected to the second fluidic reservoir so that the second fluidic reservoir collects the biomolecule after it translocates through the nanopore.

The first insulating layer, the functional layer and second insulating layer are placed in order, which means that the first insulating layer is in contact with a first surface of the functional layer, and a second surface of the functional layer opposite to the first surface is in contact with the second insulating layer.

The functional layer is made of a conducting material having a layered structure comprising transition metal dichalcogenides such as WS₂, MoSe₂, MoTe₂, MoS₂, and NbSe₂, transition metal oxides, graphite, reduced graphene oxide, partially hydrogenated graphene, VS₂, TiS₂, TaS₂, ZrS₂, BNC, or Bi₂Sr₂CaCu₂Oₓ. The thickness of the functional layer is in the range of from 0.335 nm to 50 nm, which is equivalent to about 1 layer to about 140 layers of the layered conducting materials. The number of layers is preferably from about 1 layer to about 50 layers, and most preferably from about 1 layer to about 10 layers.

The graphite comprises preferably from about 1 layer to about 100 layers, more preferably from about 1 layer to about 50 layers, and most preferably from about 1 layer to about 10 layers.

The partially hydrogenated graphene may be formed by reacting graphene with hydrogen so that part of the sp² bond of the graphene is converted to C—H sp^{a} bond or by absorbing hydrogen atoms on the graphene surface.

The layered BNC is a hybrid material of boron nitride and graphene, consisting of boron, nitrogen and carbon elements. The electrical properties of BNC is determined by the relative composition of conducting graphene and insulating BN, thus is tunable by adjusting the ratio of boron, nitrogen and carbon (Lijie Ci et al., Atomic layers of hybridized boron nitride and graphene domains, Nature Materials, 2010(9): 430-435).

The nanopore has a circular, elliptical, or polygonal shape with a maximum transverse dimension of preferably from about 1 to about 2000 nm.

The micro-nanometer separation channel has a circular, elliptical, or polygonal shape with a maximum transverse dimension of preferably from about 1 to about 2000 nm. The longitudinal dimension (length) of the micro-nanometer separation channel may be non-uniform, for example, the length may be reduced from the entrance to the position where it connects to the nanopore. Nanostructures such as nanopillars may be provided at the entrance and the exit of the micro-nanometer separation channel to facilitate the separation of DNA molecules and the entry of the DNA into the channel.

The distance between the two electrical contact layers which form electrical contacts with the functional layer is preferably in the range of from about 0.05 μm to 1000 μm. The two electrical contact layers may also be in contact with the first insulating layer and the second insulating layer. Optionally, separate electrical contacts to the first and the second insulating layers may be provided so that electrostatic gating can be achieved through the first or the second insulating layer independently.

The distance between the source electrode and the drain electrode that are in electrical contacts with the functional layer is preferably in the range of from about 0.05 μm to 1000 μm. The source and the drain electrodes may also be in contact with the first insulating layer and the second insulating layer. Optionally, separate electrical contacts to the first and the second insulating layers may be provided so that electrostatic gating can be achieved through the first or the second insulating layer independently.

The width of the nanometer functional layer is preferably in the range of from about 0.01 μm to about 1000

The thickness of the first insulating or the second insulating layers is preferably in the range of from about 0.01 μm to about 1000 μm.

In order to obtain reliable and stable signals, the biosensor may include an encapsulation layer to protect the functional unit or the entire biosensor.

To achieve a single-base resolution, the present invention employs layered conducting materials such as graphene (having a thickness of 0.335 nm) as the functional layer. In order to overcome the difficulty in forming a nanopore in the functional layer having an atomic scale thickness, the functional layer is sandwiched between two insulating layers. In order to control the movement of biomolecules investigated and their conformations as the biomolecules translocate through the nanopore, the functional unit is integrated with a micro-nano fluidic system unit. Since the nanopore extends through the full thickness of the functional unit, it may minimize the influence of potential orientation changes of DNA bases as DNA bases translocate through the nanopore on the electrical signal detection. Although the biosensor employing a functional unit possesses a relative simple structure comparing to the biosensor with a functional unit incorporated into a field effect transistor unit, in this simple structure, only current flowed between the fictional layer and electrical contact layers may be detected for identifying DNA sequences. In contrast, when the functional unit is incorporated into the field effect transistor unit, the field effect characteristics such as current flowed between the source and the drain electrodes, transfer characteristics, and threshold voltage may all be used for sequencing DNA molecules. In the present invention, the functional unit and the field effect transistor unit may be referred to as a signal detection unit for the measurement of electrical, optical, or other signals.

The employment of a functional layer with an atomic-scale thickness in the biosensor enables the detection of electrical characteristics of individual base of DNA molecules. The biosensor of the present invention thus is suitable for direct, inexpensive, and rapid DNA sequencing. The fabrication of the biosensor disclosed herein is simple. Sandwiching the functional layer between two insulating layers makes the biosensor more robust. The insulating layers also protect the biosensor from contamination and unnecessary environmental impact. Making nanopore extending through the full thickness of the functional unit minimizes the potential influence of orientation changes of DNA bases on the electrical signal detection as they translocate through the nanopore. The integration of the micro-nano fluidic system unit with the field effect transistor unit or the functional layer unit is advantageous to control interactions between the biomolecules and the functional layer and to detect unique electrical properties for biomolecule analysis. Since the thickness of the functional layer is comparable to the characteristic length of the biomolecules investigated, the biosensor is capable of studying specific properties of the molecules.

The basic working principle of the biosensor is described thereafter. DNA molecules are linearized under the electrophoresis field, and move from the first fluidic reservoir to the second fluidic reservoir via the micro-nanometer separation channels and the nanopore in the functional unit. When bases of a DNA molecule is translocating through the nanopore, the bases interact with the functional layer one base at a time such that the biosensor can monitor changes in the electrical characteristics due to the presence of base-specific interactions between the bases and the functional layer. It should be noted that the high-resolution biosensor disclosed herein may be used to detect biomolecules under different work principles, and the present invention focuses on the basic device structure of the biosensor.

For clarification, the present invention takes DNA molecules as one example for the purpose of description. The biosensor of the present invention may also be used to analyze other biomolecules such as RNA and proteins. The biosensor of the present invention detects biomolecules by measuring changes in electrical characteristics. It may also detect biomolecules by measuring changes in other characteristics, for example, optical signals.

### BRIEF DESCRIPTION OF THE DRAWINGS

The foregoing summary as well as the following detailed description of preferred embodiments of the invention will be better understood when read in conjunction with the appended drawings. For the purpose of illustrating the invention, there are shown in the drawings embodiments which are presently preferred. It should be understood, however, that the invention is not limited to the specific methods, compositions, devices, and precise arrangements disclosed. In addition, the drawings are not necessarily drawn to scale. In the drawings:

FIG. 1 shows a high-resolution biosensor with a functional unit as the signal detection unit according to an embodiment of the present invention.

FIG. 2 shows a high-resolution biosensor with a field effect transistor unit comprising the functional unit as the signal detection unit according to an embodiment of the present invention.

FIG. 3 is a flow diagram illustrating fabrication of the functional unit according to an embodiment of the present invention.

FIG. 4 is a schematic view of a micro-nano fluidic system unit according to an embodiment of the present invention.

FIG. 5 is a flow diagram illustrating fabrication of the field effect transistor unit according to an embodiment of the present invention.

FIG. 6 is a schematic view of a high-resolution biosensor comprising n functional units disposed in parallel as the signal detection unit according to an embodiment of the present invention. Here, n is an integer equal to or larger than 1.

FIG. 7 is a schematic view of a high-resolution biosensor comprising n field effect transistor units deposed in parallel on a chip as the signal detection unit according to an embodiment of the present invention. Herein, a bottom gate electrode configuration is adopted, and n is an integer equal to or larger than 1.

FIG. 8 is schematic view of a high-resolution biosensor comprising of n field effect transistor units disposed paralleled on a chip as the signal detection unit according to an embodiment of the present invention. Herein, a top gate electrode configuration is adopted, and n is an integer equal to or larger than 1.

FIG. 9 is a schematic view of a biosensor array comprising n signal detection units and N micro-nano fluidic system units. Here, n and N are integers equal to or larger than one.

FIG. 10 is a schematic view illustrating applying pulse electric fields to perform electronic DNA sequencing using a biosensor of the present invention. The pulse electric fields includes electrophoresis pulse for driving DNA driving and control of movement kinetics, mode-locked pulse for controlling interactions between DNA bases and the functional layer, pulse applied to the single detection unit for detecting signals, and pulse for automatically analyzing nucleotide sequence.

Figures show: substrate 1, dielectric layer 2, third insulating layer 3, first insulating layer 4, functional layer 5, second insulating layer 6, source electrode 7, drain electrode 8, gate electrode 9, electrical contact layer 70, electrical contact layer 80, first electrophoresis electrode 10, second electrophoresis electrode 11, first fluidic reservoir 12, second fluidic reservoir 13, micro-nanometer separation channel 14, biomolecule 15, nanopore 16, encapsulation layer 17, functional unit (signal detection unit) 20, micro-nano fluidic system unit 25, field effect transistor unit 30, biosensor 40, biosensor array 50.

### DETAILED DESCRIPTION OF THE PREFERRED EMBODIMENTS

The present invention relates to an apparatus and method for biomolecule analysis such as nucleic acid (DNA or RNA) sequencing at a single molecule level. More particularly, it relates to obtain genetic sequence information by direct reading of a DNA or RNA molecule base by base. In the following description, techniques and mechanisms of the present invention will sometimes be described in singular form for clarity. However, it should be noted that some embodiments can include multiple iterations of a technique or multiple applications of a mechanism unless specified otherwise.

The basic device structure of the high-resolution biosensor in the present invention includes a micro-nano fluidic system unit 25 and a signal detection unit which may be a functional unit 20 or a field effect transistor unit 30. The movement dynamics of biomolecules such as DNA may be well controlled by the micro-nano fluidic system unit 25, and identification of base sequence of a DNA molecule may be achieved by the analysis of signals detected by the signal detection unit.

To accomplish the goal of analyzing specific characteristics of the biomolecules, the functional layer 5 is made of a conducting material having a layered structure. The conducting material includes, but not limited to, transition metal dichalcogenides such as WS₂, MoSe₂, MoTe₂, MoS₂, and NbSe₂, transition metal oxides, graphite, reduced graphene oxide, partially hydrogenated graphene, VS₂, TiS₂, TaS₂, ZrS₂, BNC, or Bi₂Sr₂CaCu₂Ox. The thickness of the functional layer is in the range of from 0.335 nm to 50 nm, which is equivalent to about 1 layer to about 140 layers of the layered conducting materials. The number of layers is preferably from about 1 layer to about 50 layers, and most preferably from about 1 layer to about 10 layers. The graphite contains preferably from about 1 layer to about 100 layers, more preferably from about 1 layer to about 50 layers, and most preferably from about 1 layer to about 10 layers. The partially hydrogenated graphene is formed by reacting graphene with hydrogen to convert part of sp² bond of the graphene to C—H sp^{a} bond, or by absorbing hydrogen atoms on the graphene surface. The layered BNC is a hybrid material of boron nitride and graphene, consisting of boron, nitrogen and carbon elements. The electrical properties of BNC is determined by the relative composition of conducting graphene and insulating BN, and thus is tunable by the ratio of boron, nitrogen and carbon (Lijie Ci et al., Atomic layers of hybridized boron nitride and graphene domains, Nature Materials, 2010(9): 430-435).

The nanopore 16 has a circular, elliptical, or polygonal shape with a maximum transverse dimension of preferably from about 1 to about 2000 nm. The shape of the nanopore is preferably circular since the circular shape can minimize the potential influence of orientation variations of bases due to different interactions between the bases and the functional layer on the signal detection.

In order to manipulate the movement, conformation and velocity of the DNA molecule as the DNA molecule translocates through the nanopore 16, a signal detection unit is integrated with the micro-nano fluidic system unit 25. The micro-nanometer separation channel 14 has a circular, elliptical, or polygonal shape with a maximum transverse dimension of preferably from about 1 to about 2000 nm. The shape of the micro-nanometer separation channel 14 is preferably circular. The micro-nanometer separation channel 14 may have a non-uniform dimension over its length such that, for example, the longitudinal dimension may be reduced from the entrance to the location where it connects to the nanopore. The entrance and the exit of the micro-nanometer separation channel 14 may contain nanostructures such as nanopillars to facilitate the separation of DNA molecules and the entry of the DNA into the channel.

In some embodiments where the functional unit 20 is used as the signal detection unit, the electrical contacts with the functional unit 20 are formed by using electrical contact layers 70, 80. The distance between the two electrical contact layers 70, 80 is preferably in the range of from 0.05 μm to 1000 μm. The electrical contact layers are connected to an external circuitry for measuring changes in electrical characteristics and for applying control signals necessary for the analysis. The electrical contact layers may be in contact only with the functional layer 5 or in contact also with the first insulating layer 4 and the second insulating layer 6. Alternatively, separate electrical contact layers being in contact with the first and second insulating layers may be employed to achieve independent electrostatic gating control to the first or second insulating layer.

In some embodiments where the field effect transistor 30 is used as the signal detection unit, the electrical contacts with the functional layer are formed by using a source electrode 7 and a drain electrode 8. The distance between the source electrode 7 and drain electrode 8 is preferably in the range of from 0.05 m to 1000 μm. The source and drain electrodes are connected to an external circuitry for measuring changes in electric characteristics and for applying control signals necessary for the analysis. The source and drain electrodes may be in contact also with the first insulating layer 4 and the second insulating layer 6. Alternatively, separate electrical contacts with the first and second insulating layers may be formed to achieve independent electrostatic gating control to the first or second insulating layer.

The width of the functional layer 5 is preferably in the range of from about 0.01 μm to 1000 μm.

The thickness of the first insulating layer 4 or the second insulating layer 6 is in the range of from 0.01 μm to 1000 μm.

### Embodiment 1

### High-Resolution Biosensor with Functional Unit 20 as Signal Detection Unit

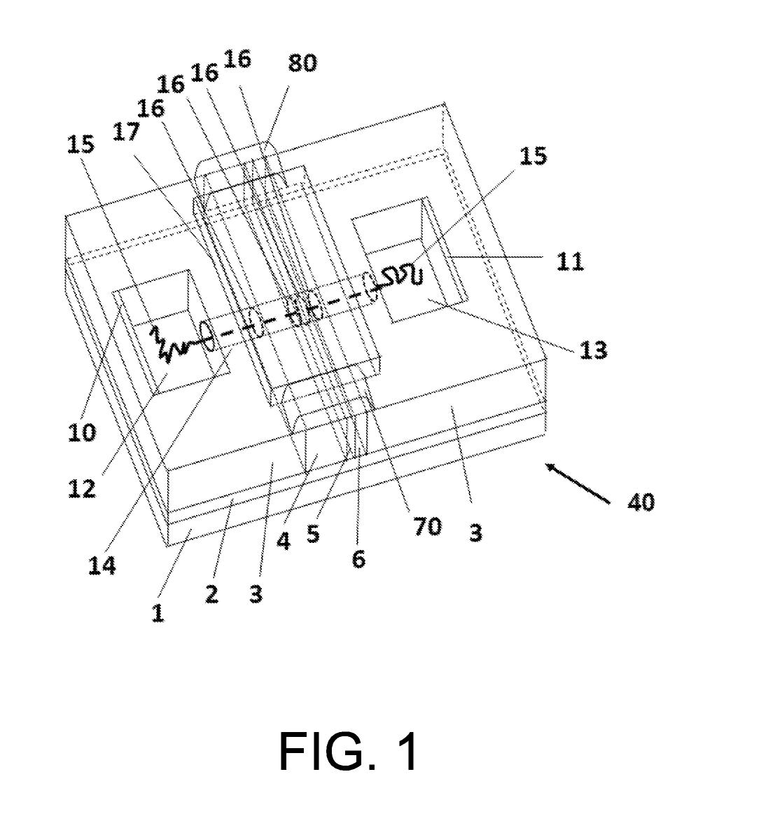

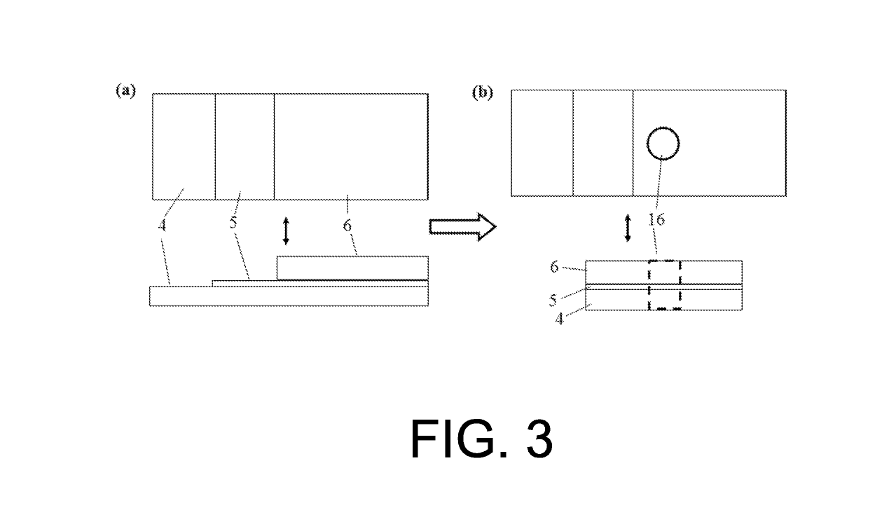

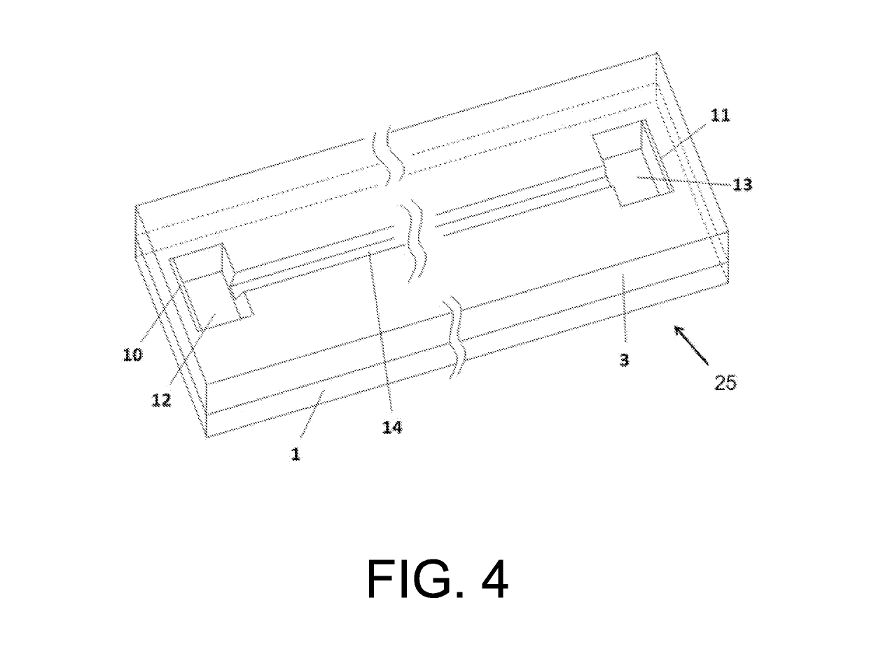

As shown in FIG. 1, the high-resolution biosensor includes a functional unit 20 and a micro-nano fluidic system unit 25. The fabrication of the functional unit and the micro-nano fluidic system unit is illustrated in FIG. 3 and FIG. 4, respectively.

The functional unit 20 includes a first insulating layer 4, a functional layer 5, and a second insulating layer 6. A nanopore 16 is formed at a central region of the functional unit 20 and extends through the first insulating layer 4, the functional layer 5, and the second insulating layer 6. The first insulating layer 4, the functional layer 5, and the second insulating layer 5 are placed in order, which means that the first insulating layer 4 is in contact with the one surface of the functional layer 5, and the second insulating layer 6 is in contact with an opposite surface of the functional layer 5. Two electrical contact layers 70, 80 are provided on the functional layer 5, forming electrical contacts with the functional layer 5. The micro-nano fluidic system unit 25 includes a first fluidic reservoir 12, a second fluidic reservoir 13, a third insulating layer 3, and micro-nanometer separation channels 14. The first fluidic reservoir 12 and the second fluidic reservoir 13 are located at opposite ends of the micro-nano fluidic system unit 25. The first fluidic reservoir 12 is connected to a first electrophoresis electrode or micropump 10, and the second fluidic reservoir 13 is connected a second electrophoresis electrode or micropump 11. The first fluidic reservoir 12 and the second fluidic reservoir 13 are separated by the third insulating layer 3. The micro-nanometer separation channels 14 are located between the first fluidic reservoir 12 and the second fluidic reservoir 13. The nanopore 16, the first fluidic reservoir 12, the micro-nanometer separation channels 14, and the second fluidic reservoir 13 are aligned and connected.

In the biosensor of the present embodiment, the third insulating layer 3 also acts as a substrate. The functional layer 5 is sandwiched between the first insulating layer 4 and the second insulating layer 6 so that the functional layer of an atomic-scale thickness may be protected by the first and the second insulating layers. Extending the nanopore through the full thickness of the functional unit may minimize potential influence of orientation changes of DNA bases during the translocation on the electrical detection. The micro-nano fluidic system unit helps to control conformation of DNA molecules as well as movement dynamics of the DNA molecules as they pass through the nanopore.

### Embodiment 2

### Fabrication of Functional Unit 20 (not Including Preparation of Electrical Contact Layers)

As shown in FIG. 3, the fabrication of the functional unit 20 may include the following steps: (a) transferring the functional layer 5 made of a single-layer graphene onto the first insulating layer 4 made of insulating hexagonal boron nitride (h-BN) (20 nm), and then coating the graphene layer with polymethylmethacrylate (PMMA) to form a second insulating layer 6 (500 nm); (b) forming a nanopore 16 of a diameter of 2 nm extending through the full thickness of the functional unit by electron beam lithography and etching techniques.

In embodiment 2, the first insulating layer is made of h-BN and the second insulating layer is made of PMMA. However, the insulating layers may be made of other insulating materials, including, but not limited to, SiO₂, Al₂O₃, SiN_{X}, SiC, fluorinated graphene, poly(vinyl alcohol), poly(4-vinylphenol), poly(methyl methacrylate), divinylsiloxane-bis-benzocyclobutene, or their combinations. As for the functional layer, it may be made not only from graphene and functionalized graphene membrane, but also from other layered conducting materials with various numbers of layers. The layered conducting materials include, but not limited to, transition metal dichalcogenides such as WS₂, MoSe₂, MoTe₂, MoS₂, and NbSe₂, transition metal oxides, graphite, reduced graphene oxide, partially hydrogenated graphene, VS₂, TiS₂, TaS₂, ZrS₂, BNC, or Bi₂Sr₂CaCu₂Oₓ. The thickness of the functional layer is in the range of from 0.335 nm to 50 nm, which is equivalent to from about 1 layer to about 140 layers of the layered conducting materials. The number of layers is preferably from about 1 layer to about 50 layers, and most preferably from about 1 layer to about 10 layers. In the present embodiment, the graphene membrane may be monolayer, bilayer, or trilayer, or consist of a few layers such as 10 layers, 50 layer or 100 layers. The number of layers is preferably from about 1 layer to about 50 layers, and most preferably from about 1 layer to about 10 layers.

In the present embodiment, the diameter of the nanopore extending through the functional unit is 2 nm. In general, the shape of the nanopore may be circular, elliptical, or polygonal with a maximum transverse dimension ranging from about 1 to about 2000 nm. The nanopore preferably has a circular shape since the circular shape can eliminate anisotropic interactions between the same kind of DNA bases (i.e., adenine, thymine, cytosine, or guanine) and the functional layer which are caused by potential changes in the orientation of the bases when they translocate through an irregular nanopore.

The nanopore may be formed by common nanofabrication methods and techniques including, but not limited to, electron beam lithography, focused ion beam lithography, pulsed ion beam etching, helium ion beam etching, and electron beam drilling from transmission electron microscopy.

The electrical contact layers that are in contact with the functional layer may be made of conducting materials, including, but not limited to, Cr, Pt, Au, Ti, Pd, Cu, Al, Ni, PSS:PEDOT, and their combinations. The electrical contact layers may be formed by various deposition methods and techniques developed in materials science including, but not limited to, thermal vapor deposition, spin-coating, low-pressure chemical vapor deposition, electron beam deposition, plasma enhanced chemical vapor deposition, sputtering, and atomic layer deposition.

### Embodiment 3

### Fabrication of Micro-Nano Fluidic System Unit 25

As shown in FIG. 4, the fabrication of the micro-nano fluidic system unit 25 may include the following steps: forming a 300 nm thick SiO₂ layer on Si wafer by thermal oxidation; forming a first fluidic reservoir 12 (2 mm×2 mm), a second fluidic reservoir 13 (2 mm×2 mm) and micro-nanometer separation channels 14 (diameter of 200 nm) by lithography and etching techniques; and depositing Pt (thickness of 30 nm) as the first and second electrophoresis electrodes 10, 11.

In the present embodiment, Si/SiO₂ is used as the platform for fabricating the micro-nano fluidic system unit 25. It should be noted that in real applications, different materials may be chosen when considering materials properties and the ease of integration with the signal detection unit. The dimensions and the shapes of the fluidic reservoirs 12, 13 and micro-nanometer separation channels 14 are determined by the practical use of the biosensor. The dimension of the micro-nanometer separation channel 14 may be uniform or non-uniform, for example, the longitudinal dimension of the micro-nanometer separation channel may be gradually reduced from the entrance to the position at which it connects to the nanopore. The entrance and the exit of the micro-nanometer separation channel 14 may contain nanostructures such as nanopillars to facilitate the separation of DNA molecules and the entry of the DNA into the channel. The micro-nanometer separation channel 14 may have a circular, elliptical, or polygonal shape. The maximum transverse dimension of the micro-nanometer separation channel is preferably from about 1 to about 2000 nm.

### Embodiment 4

### High-Resolution Biosensor with Field Effect Transistor Unit as Signal Detection Unit

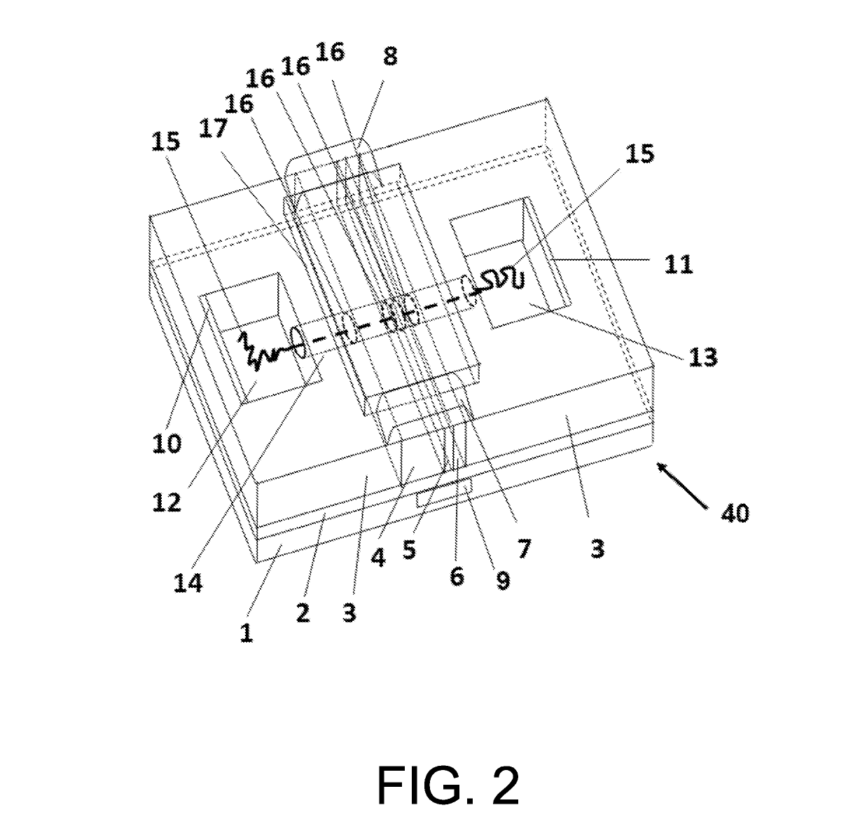

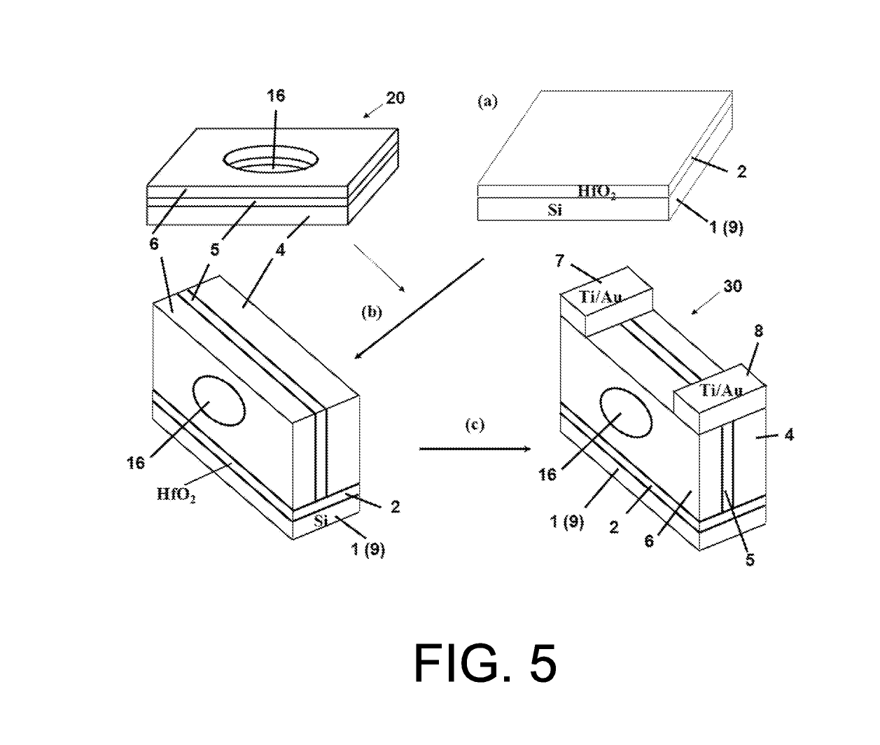

Referring to FIG. 2, the high-resolution biosensor includes a field effect transistor unit 30 (fabrication process of the field effect transistor unit is shown in FIG. 5) as the signal detection unit and a micro-nano fluidic system unit 25 (FIG. 4).

The field effect transistor unit 30 includes a substrate 1, a dielectric layer 2, a source electrode 7, a drain electrode 8, a gate electrode 9, and a functional unit 20. The functional unit 20 includes a first insulating layer, a functional layer, and a second insulating layer. A nanopore 16 is formed at a central region of the functional unit 20 and extends through the first insulating layer 4, the functional layer 5, and the second insulating layer 6. The first insulating layer 4, the functional layer 5, and the second insulating layer 6 are placed in order. The source electrode 7 and the drain electrode 8 are provided on the functional layer 5, forming electrical contacts with the functional layer 5. The micro-nano fluidic system unit 25 includes a first fluidic reservoir 12, a second fluidic reservoir 13, a third insulating layer 3, and micro-nanometer separation channels 14. The first fluidic reservoir 12 and the second fluidic reservoir 13 are located at opposite ends of the micro-nano fluidic system unit 25. The first fluidic reservoir 12 is provided with a first electrophoresis electrode or micropump 10 and the second fluidic reservoir is provided with a second electrophoresis electrode or micropump 11. The first fluidic reservoir 12 and the second fluidic reservoir 13 are separated by the third insulating layer 3. The micro-nanometer separation channels 14 are located between the first fluidic reservoir 12 and the second fluidic reservoir 13. The nanopore 16, the first fluidic reservoir 12, the micro-nanometer separation channel 14, and the second fluidic reservoir 13 are aligned and connected.

In the biosensor of the present embodiment, the functional layer is sandwiched between the first insulating layer and the second insulating layer so that the functional layer of an atomic-scale thickness is protected by the first insulating and the second insulating layers. Forming a nanopore extending through the full thickness of the functional unit may minimize potential influence of orientation changes of the DNA bases during the translocation on electrical signal detection. The integration of a functional unit into the field effect transistor is very advantageous for electrical signal detection. The field effect characteristics, including current flowed between the source and the drain electrodes, transfer characteristics, and threshold voltage, may all be used as detection signals. The micro-nano fluidic system unit helps to control conformation of DNA molecules as well as movement dynamics of DNA molecules when they pass through the nanopore.

### Embodiment 5

### Fabrication of Field Effect Transistor Unit 30

As shown in FIG. 5, the fabrication of the field effect transistor unit 30 may include the following steps: (a) depositing a layer of 30 nm thick HfO₂ as the dielectric layer 2 on a Si (500 μm) substrate by atomic layer deposition method. Herein, the Si substrate is also used as the gate electrode; (b) transferring the functional unit onto the Si (500 μm)/HfO₂ (30 nm); (c) depositing Ti (2 nm)/Au (50 nm) onto the functional unit as the source and drain electrodes by lithography technique. The distance between the source electrode and the drain electrode is 20 μm.

In the present embodiment, a 500 μm thick Si wafer is used as the substrate. It should be noted that other materials of different thicknesses may also be used as the substrate. These materials include, but not limited to, GaN, Ge, GaAs, SiC, Al₂O₃, SiNₓ, SiO₂, HfO₂, poly(vinyl alcohol), poly(4-vinylphenol), divinyl siloxane-bis-benzocyclobutene, and poly(methyl methacrylate). Highly doped Si substrate in the present embodiment is also functioned as the gate electrode.

In the present embodiment, HfO₂ is used as the dielectric layer. It should be noted that, the dielectric layer may be made of other insulating materials including, but not limited to, SiO₂, Al2O₃, SiNₓ, SiC, fluorinated graphene, poly(vinyl alcohol), poly(4-vinylphenol), poly(methyl methacrylate), divinylsiloxane-bis-benzocyclobutene, and their combinations. The dielectric layer may be fabricated by various techniques including, but not limited to, vacuum thermal evaporation deposition, spin-coating, low-press chemical vapor deposition, electron beam deposition, enhanced plasma chemical vapor deposition, sputtering, and atomic layer deposition.

The source and drain electrodes which are electrically contacted with the functional layer may be made of the materials including, but not limited to, Ti/Au, Cr, Pd, Pt, Cu, Al, Ni, and PSS:PEDOT. The fabrication can be done by using various deposition methods and techniques developed in materials science including, but not limited to, thermal vapor deposition, spin-coating, low-pressure chemical vapor deposition, electron beam deposition, plasma enhanced chemical vapor deposition, sputtering, and atomic layer deposition. The distance between the source electrode and the drain electrode is preferably in the range of from 0.05 μm to 1000 μm. In the present embodiment, the distance is 20 μm.

Patterning of the source and drain electrodes may be done by techniques known in the art such as masking, photolithography, electron beam lithography, ion beam lithography, and plasma lithography.

### Embodiment 6

### Biosensor Array

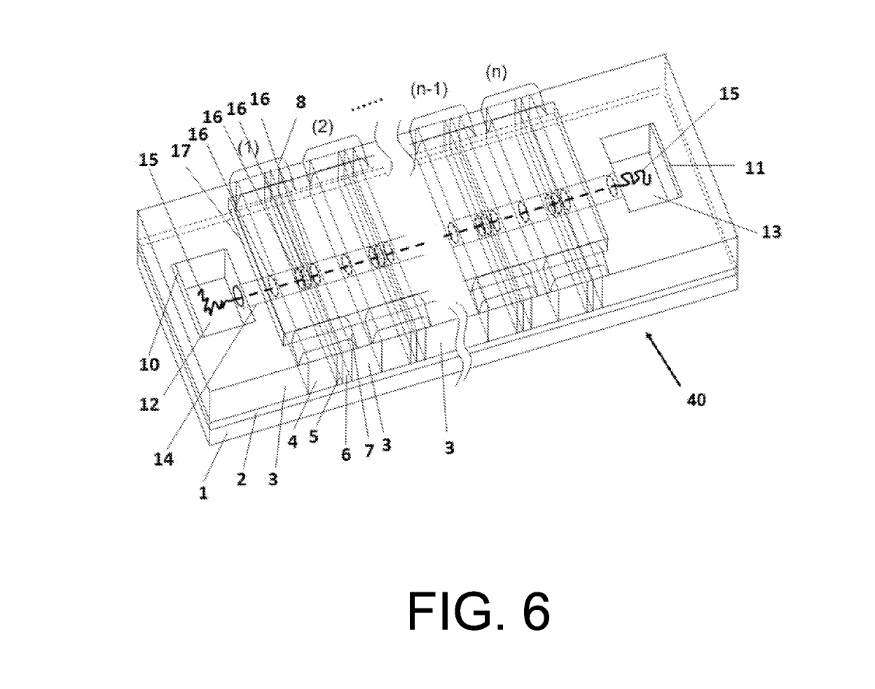

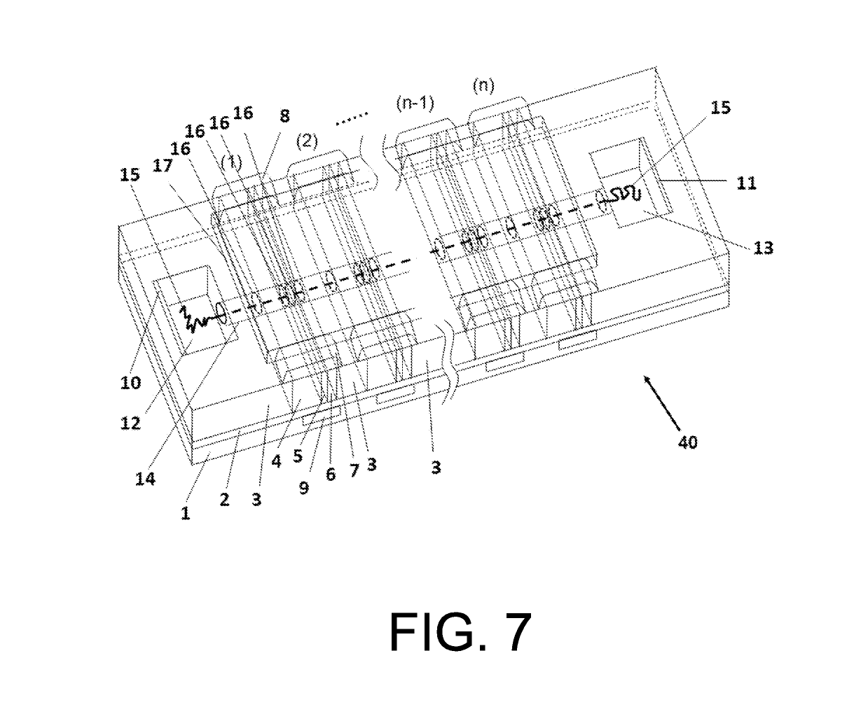

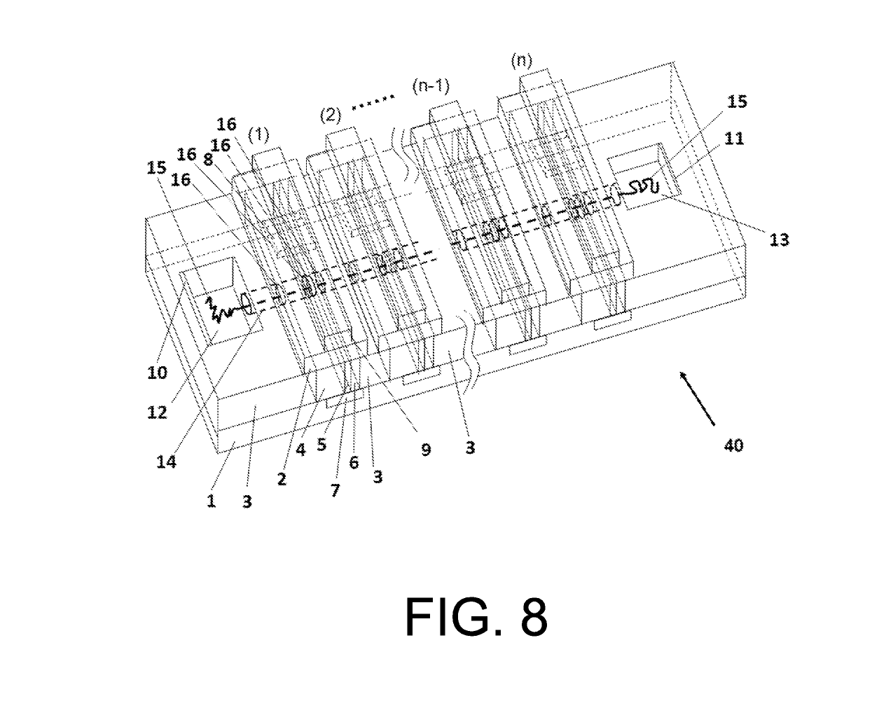

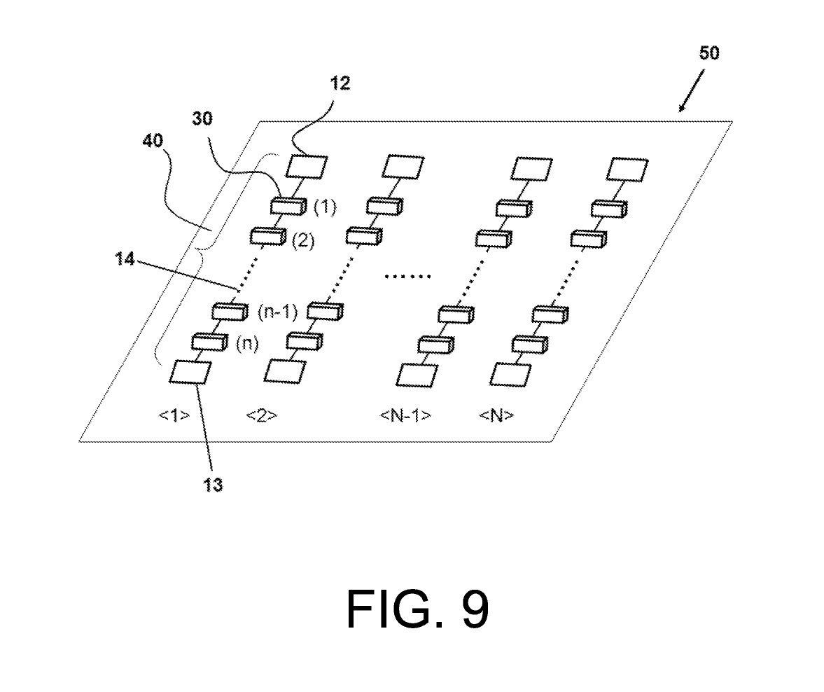

In order to achieve optimal performance of biomolecule analysis, multiple signal detection units may be integrated in serial and/or in parallel with micro-nano fluidic system units so that cross-comparison and correction can be obtained to increase the accuracy and efficiency. As shown in FIGS. 6-9, n signal detection units (i.e., functional units 20 or field effect transistor units 30) and N micro-nano fluidic units N form a biosensor array 50. Here, n and N are integers equal to or larger than one.

The high-resolution biosensor is fabricated based on its application and materials involved in the biosensor are selected according to required functions of the biosensor.

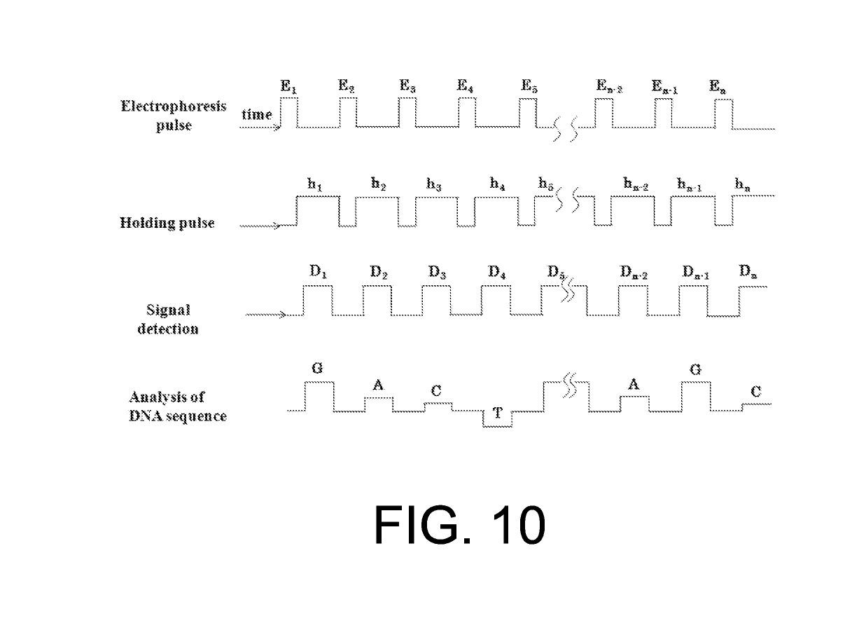

To sequence a DNA molecule using the high-resolution biosensor of the present invention, the following coordinated steps as illustrated in FIG. 10 may be performed. Various DNA base detection processes are synchronized to the actions of the programmed electrophoresis and holding electric fields.

1) A DNA molecule is linearized and moved from the first fluidic reservoir to the second fluidic reservoir via the micro-nano fluidic channels as well as the nanopore under electrophoresis field;

2) As DNA bases translocate through the nanopore one by one, a pulse electric field is applied to stop the base for a short time, thus controlling the interaction between the base and the functional layer. Simultaneously, the change in electrical characteristics of the system induced by the interaction is detected by the functional unit;

3) Through data acquisition, a characteristic profile of the interaction signals can be established for each of the four distinct DNA bases. These characteristic signal profiles can then be used to identify the DNA sequence.

While the present invention has been described with reference to the preferred embodiments, it will be obvious to those skilled in the art that various changes and modifications may be made therein without departing from the scope of the invention as defined by the appended claims. Although the aforementioned embodiments provide detailed description of configurations, characteristics and fabrication methods of nanopore sensors of the present invention, these embodiments do not limit the scope of the present invention.

1-18. (canceled)

19. A high-resolution biosensor, comprising:
a signal detection unit comprising a functional unit, the functional unit comprising:
a first insulating layer,
a second insulating layer,
a functional layer sandwiched between the first insulating layer and the second insulating layer, and
a nanopore formed in and extended through the first insulating layer, the functional layer and the second insulating layer; and
a micro-nanofluidic system unit formed in a third insulating layer, comprising:
a first fluidic reservoir formed at a first end of the third insulating layer;
a second fluidic reservoir formed at a second end of the third insulating layer opposite to the first end,
a first micro-nanometer separation channel connecting to the first fluidic reservoir, the first micro-nanometer separation channel configured to fluidically connect the first fluidic reservoir to a first end of nanopore, and
a second micro-nanometer separation channel connecting to the second fluidic reservoir, the second micro-nanometer separation channel configured to fluidically connect the second fluidic reservoir to a second end of the nanopore.

20. The high-resolution biosensor of claim 19, wherein the signal detection unit is a field effect transistor unit comprising a functional unit.

21. The high-resolution biosensor of claim 20, wherein the field effect transistor unit comprises:
a substrate having a gate electrode formed thereon;
a dielectric layer disposed on the substrate;
a functional unit disposed on the dielectric layer, the functional unit comprising:
a first insulating layer,
a second insulating layer,
a functional layer sandwiched between the first insulating layer and the second insulating layer, and
a nanopore formed in and extended through the first insulating layer, the functional layer and the second insulating layer, the nanopore extending through; and
a source electrode and a drain electrode disposed on the functional unit to form electrical contacts with at least the functional layer.

22. The high-resolution sensor of claim 19, wherein the functional unit further comprises a first and a second electrical contact layers to form electrical contacts with at least the functional layer.

23. The high-resolution sensor of claim 19, wherein the micro-nanofluidic system unit further comprises a first electrophoresis electrode or micropump being connected to the first fluidic reservoir, and a second electrophoresis electrode or micropump being connected to the second fluidic reservoir.

24. The high-resolution sensor of claim 19, wherein the first and micro-nanometer separation channel further comprises nanostructures including nanopillars provided at an entry portion and an exit portion of the channel, and wherein the second and micro-nanometer separation channel further comprises nanostructures including nanopillars provided at an entry portion and an exit portion of the channel.

25. The high-resolution biosensor of claim 19, wherein the functional layer is made of a conducting material having a layered structure comprising graphite, reduced graphene oxide, partially hydrogenated graphene, WS₂, VS₂, TiS₂, TaS₂, ZrS₂, MoSe₂, MoTe₂, BNC, MoS₂, NbSe₂, or Bi₂Sr₂CaCu₂Ox, and wherein the functional layer has a thickness ranging from 0.335 nm to 50 nm.

26. The high-resolution biosensor of claim 19, wherein the nanopore is formed at a central region of the functional unit and has a circular, elliptical, or polygonal shape with a maximum transverse dimension of preferably from about 1 to about 2000 nm, and wherein the first and the second micro-nanometer separation channels have a circular, elliptical, or polygonal shape with a maximum transverse dimension of preferably from about 1 to about 2000 nm.

27. The high-resolution biosensor of claim 19, further comprising an encapsulation layer configured to protect the functional unit or the entire biosensor.

28. A high-resolution biosensor, comprising:
a signal detection unit comprising a plurality of functional units disposed in parallel, each of the functional units comprising:
a first insulating layer,
a second insulating layer,
a functional layer sandwiched between the first insulating layer and the second insulating layer, and
a nanopore formed in and extended through the first insulating layer, the functional layer and the second insulating layer; and
a micro-nanofluidic system unit formed in a third insulating layer, comprising:
a first fluidic reservoir formed at a first end of the third insulating layer;
a second fluidic reservoir formed at a second end of the third insulating layer opposite to the first end, and
a plurality of micro-nanometer separation channels disposed between the first fluidic reservoir and the second fluid reservoir, the micro-nanometer separation channels are configured to fluidically connect the first fluidic reservoir to a nanopore in an adjacent functional unit, the second fluidic reservoir to a nanopore in an adjacent functional unit, and two nanopores in any adjacent functional units.

29. The high-resolution biosensor of claim 28, wherein the signal detection unit is a plurality of field effect transistor units, each of the field effect transistor unit comprised a functional unit.

30. The high-resolution biosensor of claim 29, wherein each of the field effect transistor units comprises:
a substrate having a gate electrode formed thereon;
a dielectric layer disposed on the substrate;
a functional unit disposed on the dielectric layer, the functional unit comprising:
a first insulating layer,
a second insulating layer,
a functional layer sandwiched between the first insulating layer and the second insulating layer, and
a nanopore formed in and extended through the first insulating layer, the functional layer and the second insulating layer; and
a source electrode and a drain electrode electrically contact with at least the functional layer.

31. The high-resolution sensor of claim 28, wherein each of the functional units further comprises a first and a second electrical contact layers forming electrical contacts with at least the functional layer.

32. The high-resolution sensor of claim 28, wherein the micro-nanofluidic system unit further comprises a first electrophoresis electrode or micropump being connected to the first fluidic reservoir, and a second electrophoresis electrode or micropump being connected to the second fluidic reservoir.

33. The high-resolution sensor of claim 28, wherein each of the micro-nanometer separation channels further comprises nanostructures including nanopillars provided at an entry portion and an exit portion of the channel.

34. The high-resolution biosensor of claim 28, wherein the functional layer is made of a conducting material having a layered structure comprising graphite, reduced graphene oxide, partially hydrogenated graphene, WS₂, VS₂, TiS₂, TaS₂, ZrS₂, MoSe₂, MoTe₂, BNC, MoS₂, NbSe₂, or Bi₂Sr₂CaCu₂Ox, and wherein the functional layer has a thickness ranging from 0.335 nm to 50 nm.

35. The high-resolution biosensor of claim 28, wherein the nanopore is formed at a central region of the functional unit and has a circular, elliptical, or polygonal shape with a maximum transverse dimension of preferably from about 1 to about 2000 nm, and wherein each of the micro-nanometer separation channel has a circular, elliptical, or polygonal shape with a maximum transverse dimension of preferably from about 1 to about 2000 nm.

36. The high-resolution biosensor of claim 28, further comprising an encapsulation layer configured to protect the functional units or the entire biosensor.

37. A biosensor array, comprising:
a plurality of the high-resolution biosensors disposed in parallel, each of the high resolution biosensor comprising:
a signal detection unit comprising a plurality of functional units, each of the functional units comprising:
a first insulating layer,
a second insulating layer,
a functional layer sandwiched between the first insulating layer and the second insulating layer, and
a nanopore formed in and extended through the first insulating layer, the functional layer and the second insulating layer; and
a micro-nanofluidic system unit formed in a third insulating layer, comprising:
a first fluidic reservoir formed at a first end of the third insulating layer;
a second fluidic reservoir formed at a second end of the third insulating layer opposite to the first end, and
a plurality of micro-nanometer separation channels disposed between the first fluidic reservoir and the second fluid reservoir, the micro-nanometer separation channels are configured to fluidically connect the first fluidic reservoir to a nanopore in an adjacent functional unit, the second fluidic reservoir to a nanopore in an adjacent functional unit, and two nanopores in any adjacent functional unit.

38. The biosensor array of claim 37, wherein the functional layer is made of a conducting material having a layered structure comprising graphite, reduced graphene oxide, partially hydrogenated graphene, WS₂, VS₂, TiS₂, TaS₂, ZrS₂, MoSe₂, MoTe₂, BNC, MoS₂, NbSe₂, or Bi₂Sr₂CaCu₂Ox, and wherein the functional layer has a thickness ranging from 0.335 nm to 50 nm.
